(19) United States
(12) Patent Application Publication
(10) Pub. No.: US 2012/0323371 A1
(43) Pub. Date: Dec. 20, 2012

(54) BELT FOR TRANSMITTING A DRIVE MOTION, DEVICE FOR DRIVING A BELT AND METHOD FOR STARTING A BELT

(75) Inventor: Ulrich Ballhausen, Bad Driburg (DE)

(73) Assignee: ARNTZ BETEILIGUNGS GMBH & CO. KG, Hoexter (DE)

(21) Appl. No.: 13/578,847

(22) PCT Filed: Jan. 14, 2011
(86) PCT No.: PCT/DE2011/000037

§ 371 Date: Aug. 14, 2012

(30) Foreign Application Priority Data
Mar. 3, 2010 (DE) 10 2010 002 551.8

(51) Int. Cl. F16G 5/20; G05B 15/02

(52) U.S. Cl. 700/275; 474/238

(57) ABSTRACT

The invention relates to a belt for transmitting a drive motion, comprising a belt body consisting of an elastic material and a carcass that extends in the longitudinal direction of the belt and that is at least partially surrounded by the belt body for increasing the strength of said belt body in the longitudinal direction of the belt. A data memory for saving data is situated in the belt body and at least one piece of information that identifies the belt is stored in the data memory. The drive motion can be enabled and/or disabled in accordance with the information that identifies the belt.

This present invention relates to a belt for transmitting a drive motion, comprising a belt body of an elastic material and a carcass that extends in the longitudinal direction of the belt and that is at least partially surrounded by the belt body for increasing the strength of said belt body in the longitudinal direction of the belt wherein a data memory for saving data is situated in the belt body.

The invention also relates to a device for driving a belt which is intended for transmitting a drive motion and in which a data memory for saving data is situated, with a reading unit for readout of said data memory and with a drive unit for driving the belt.

Moreover, this invention relates to a method for starting a belt wherein the belt fitted with a data memory is driven by a drive unit.

Prior known from DE 10 2006 002 118 A1 is a belt drive comprising a belt with a marker. This marker is of active type to generate and emit an electric and/or magnetic field or optical radiation. It may be a Hall sensor or a transponder, for instance. A stationary detector is arranged in a spaced relation from the belt to detect signals emitted by the marker while said latter is moving past said detector. Reading out the marker permits to assess the position and speed of the belt and in particular to a belt position change and/or displacement due to wear, tolerance or temperature. It cannot be made sure, however, that only such belts are used which are allowed to operate in a specific belt drive and which conform to a manufacturer's specifications in regard to such parameters as speed and tensile strength.

It is an object of this present invention, therefore, to provide a belt, a device for driving the belt and a method for starting the belt in such a way that the operational reliability and dependability are further increased while at the same time keeping the extent of production effort to a minimum.

To achieve this object the invention is in conjunction with the preamble of Patent Claim 1 characterized by the fact that data stored in the data memory comprise at least one piece of belt identifying information with provision made for the drive motion to be disabled and/or enabled in accordance with the information that identifies the belt.

The particular advantage of the invention resides in that the belt, the belt type, the belt manufacturer, geometric parameters such as the shape or length as well as functional parameters such as the maximum permissible speed or the force that can be transmitted can be stored in a data memory integrated in the belt itself. This belt identifying information can be read out quickly and reliably by means of a suitable reading unit and electronically processed. The respective information may be used for logistic purposes, for instance, to check and ensure prior to shipment of the belt and/or for putting a belt on stock and withdrawing it from the store that a belt is actually the specified article. Moreover, it is possible for a manufacturer to bar the use of and call back a particular belt (provided it has its own belt number) when material defects have been discovered in other belts of the same production batch, for instance. Electronic readout in this case is possible not only in an easy way, but also quickly and with extreme reliability. Readout and/or transmission errors can be avoided in such a case of electronic readout and processing.

Where a belt is part of a belt drive or the like it is possible to read out the integrated data memory while the belt is operating or being started. The readout information can be compared with reference data comprising identifying information on belt types that are allowed and/or practice tried for a specific belt drive. The drive motion may be disabled and/or enabled dependent on the result of such a comparison.

Disabling or enabling a drive motion in the sense of this invention means that belt starting out of a standstill condition is inhibited and/or that a belt already started is again stopped a short time after it has been started. Disabling of a belt in the standstill state is involved particularly when the belt in standstill condition is positioned such that a reading unit can read out the data memory, and momentary starting and subsequent stopping of the belt when the data memory gets into the readout range of the reading unit on initiation of a starting motion only. Enabling the drive motion analogously comprises the issue of a permission to start the belt out of its standstill condition and a subsequent authorization of said drive motion after readout of the data memory moving past the reading unit and compliance of the belt identifying information stored in the data memory with likewise stored reference data. Stored reference data may for instance comprise information on admissible belt types, belt identification numbers and/or manufacturer specifications. Also it is possible in the sense of a barring list to interdict the use of individual belts (identified by their own belt number) or belt batches when for instance a material defect has been discovered or there is some other callback situation on the manufacturer side. Moreover, performance restrictions (for instance in regard to speed or torque) may be carried into effect if so deemed necessary whenever defective batches, wrong fringe conditions, defective production or the like have been discovered.

The belt body may for instance be produced by vulcanizing in which case the data memory will be embedded into the rubber matrix to be vulcanized when building up the belt body. Alternatively, the belt body can be produced by a suitable injection molding process. In that case, the data memory is placed into the mold and surrounded with plastic by injection molding. The material used may for instance comprise interlaced and/or thermoplastic polyurethanes or thermoplastic vulcanized elastomers (TPE-V, tradename for instance Santoprene being a blend consisting of polypropylen and vulcanized EPDM).

A preferred embodiment of the invention provides for the data memory to be disposed in the region of the neutral fiber of the belt body which when bent around a bending axis extending cross to the belt longitudinal axis will not be subjected to tension and/or pressure, in the region of the carcass and/or in the region of a local material accumulation, and to be at least partially surrounded by the belt body material. This affords the advantage that the data memory is protected inside the belt body. Mechanical effects, in particular impacts or vibrations, thermal influences as well as chemicals which may come into contact with the belt during storage or operation thereof cannot detrimentally affect the data memory.

To surround the data memory with belt body material the data memory will be inserted into the rubber matrix to be vulcanized and/or into the mold cavity prior to vulcanizing and/or injection molding already such that after vulcanizing and/or injection molding the data memory is at least partially surrounded by the belt body. It has been a surprise to discover that the data memory is protected to such an extent in the region of the carcass and/or of a local material accumulation, i.e. within a large homogenous rubber region as existing in the area of a tooth of a toothed belt or a rib of a ribbed belt that extends in the belt longitudinal direction, that the data memory “survives” without damage the high temperatures of up to 180° C. and the high pressures of up to 15 bar as involved in a vulcanizing and/or injection molding process. This method is particularly economical and suitable for mass production.

A modification of this invention provided for the data memory to be part of an integrated circuit which together with an antenna coupled to said latter forms an RFID transponder. This affords the advantage that a passive data memory is provided that can be read out from outside in a no-contact mode and that does not require any connection to an energy accumulator means for either data storage or data transmission such that no energy accumulator means, for instance a battery, has to be incorporated into the belt body. Such waiver of an energy accumulator means moreover results in a high or theoretically even infinite service life. RFID transponders as mass products are very favorable in cost such that a high economic efficiency will be ensured.

Another modification of the invention provides for the data memory, the integrated circuit and/or the antenna to be at least partially surrounded by a protective sheath.

Provision of such a protective sheath increases the resistibility of the functional components integrated therein (integrated circuit with data memory, antenna) and also prevents any direct contact of the functional components with the material or the belt body and/or carcass so that damages to said functional components for instance due to mechanical friction and/or chemical reactions are avoided. Said protective sheath moreover protects the data memory during the vulcanizing process.

According to a further modification of the invention is the protective sheath a tight coating. It contains no or just little air such that advantageously the life of the data memory is even further increased and contamination is prevented.

Still another modification provides for the protective sheath to consist of a glass material or plastic, i.e. preferably of low-reaction material whose exact chemical composition may be selected such as to prevent any reaction with functional components surrounded by said protective sheath on the one hand and with the material of the belt body or the carcass on the other hand. The long-time stability of the belt comprising the data memory can be further improved this way. Provision of a protective sheath of a hard temperature-resistant material (glass or suitable plastics) helps to reduce the mechanical and thermal load on the data memory during the vulcanizing process and/or in use.

To achieve the previously defined object the invention is in conjunction with the preamble of Patent Claim 7 characterized by the fact that a belt identifying information is stored in a data memory of the belt and that a control unit coacting with the reading unit and the drive unit is provided such that dependent on the result of a comparison of the belt identifying information with stored reference data a control signal can be emitted to the drive unit for disabling and/or enabling the belt drive motion.

The particular advantage of this invention resides in that the drive unit operates the belt only if a belt allowed by the manufacturer is being used whereas the drive motion can otherwise be disabled. This significantly increases the operational safety of the belt and inhibits both accidental starting of the device with a belt that is not suitable for a defined application and incorrect startup of the drive unit after assembly of a non-allowed product.

To achieve that object the invention is in conjunction with the preamble of claim 9 characterized by the fact that at least one piece of belt identifying information is read out from the data memory of the belt and compared for compliance with reference data such that a drive motion may be enabled in case of compliance and/or disabled in case of non-compliance of the comparison result.

The particular advantage of the invention is that due to comparison of the belt identifying information stored in the belt with reference data it is possible to inhibit the use of non-allowed belts, for instance belts not tested or found unsuitable. Accidental use of a wrong belt can be prevented just like a misuse of poor-quality fake belts can be.

In a preferred embodiment of the invention the data memory will be read out in a non-recurrent or recurrent mode. Especially in case of recurrent readout of the data memory it may be concluded during normal operation and when knowing the speed of the drive motion that there is a defect in the belt and/or reading unit in case of non-appearance of an expected signal. Moreover, it is possible in cases of recurrent data memory readout to detect in addition to the belt identifying information at least such operational parameters of the belt and/or the device also that are temporarily stored in the data memory. Such operational parameters can be detected by sensors which are disposed inside and/or outside the belt and relate to such conditions as temperature, elongation and pressure. They can be used for an early recognition of a forthcoming failure of a belt or to obtain statements as to the operational behavior of a load carried by a belt.

Further advantages of the invention are as disclosed in the subclaims.

The invention will now be described in closer detail with reference to drawings:

In the drawings:

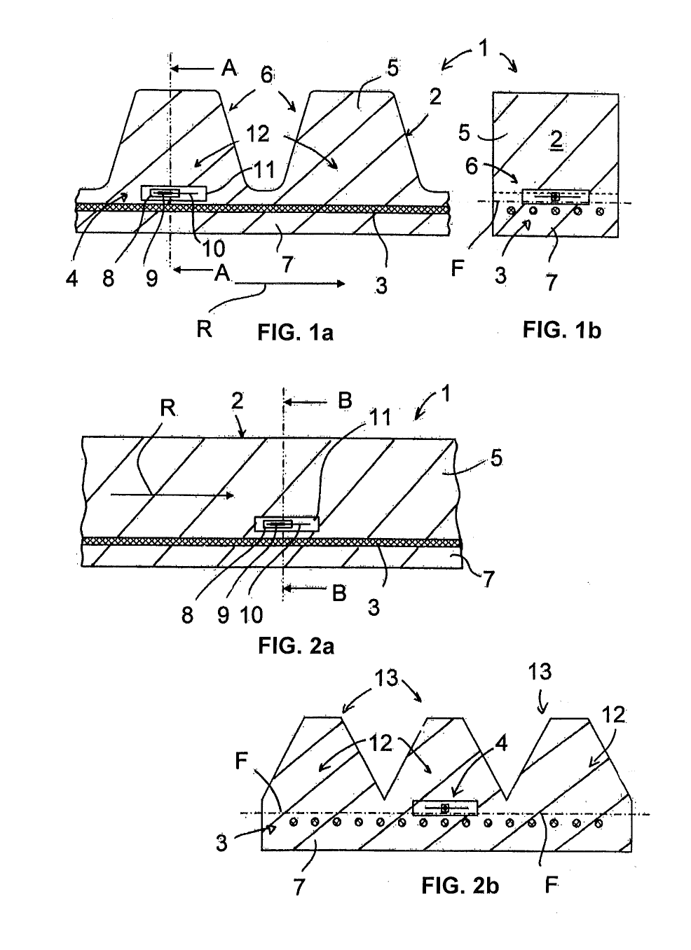

FIG. 1a is a longitudinal section through a belt in a first embodiment with a data memory embedded in the belt;

FIG. 1b is a cross-section through the belt according to FIG. 1a along section line A-A;

FIG. 2a is a longitudinal section through a belt in a second embodiment with a data memory embedded in the belt;

FIG. 2b is a cross-section through the belt according to FIG. 2a along section line B-B;

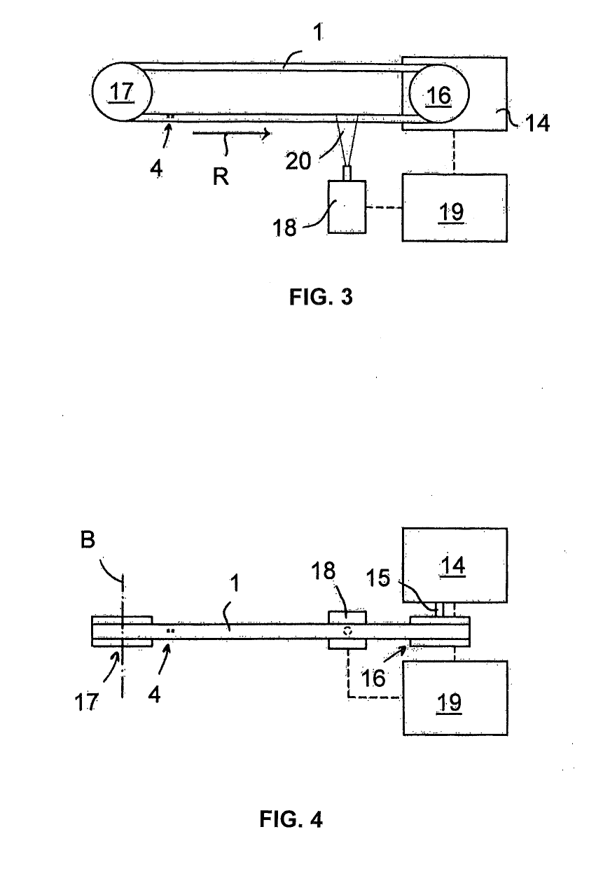

FIG. 3 is a side view of a device for driving a belt; and

FIG. 4 is a top view of the device according to FIG. 3.

A toothed type belt 1 according to FIGS. 1a and 1b comprises as central components a belt body 2 made of a vulcanized elastic material, a carcass 3 extending along the belt body 2 in a belt longitudinal direction R and consisting of a plurality of individual cords, and an RFID transponder 4. A belt 1 of that type is for instance used in a belt drive for transmitting a drive motion to an output shaft.

The belt body 2 has an engaging portion 5 comprising teeth 6 that are tandem arranged in the belt longitudinal direction R and a back portion 7 adjacent to said engaging portion 5. The carcass 3 extends in the belt longitudinal direction R in said back portion 7. Said carcass 3 serves to increase the strength or stability of the belt in said belt longitudinal direction R.

The RFID transponder 4 is embedded in the belt body 2 in the region of the carcass 3 and a neutral fiber F of the belt 1. Said neutral fiber F is not subjected to tension or pressure when the belt 1 is bent around a bending axis B extending cross to the belt longitudinal axis R. The data memory 9 is hence exposed to just a minor bending load. Moreover, the RFID transponder 4 is disposed in the region of a local material accumulation 12 which is formed by the large homogenous rubber area of the tooth 6. When building up a belt 1 said arrangement of the RFID transponder 4 in the region of the carcass 3, the neutral fiber F and the local material accumulation 12 formed by the tooth 6 permits to insert said transponder 4 into the rubber matrix to be vulcanized and then to vulcanize the same. Contrary to what had been expected it has been found out that the thus defined position in coaction with the protective sheath 11 surrounding the RFID transponder 4 result in that the high temperatures of up to 180° C. and the high pressures of up to 15 bar which are involved during the vulcanizing process are not damaging the RFID transponder 4.

In another embodiment of the invention according to FIGS. 2a and 2b the belt 1 is a ribbed belt with ribs 13 extending in the belt longitudinal direction R. The RFID transponder 4 is arranged in the region of the neutral fiber F adjacent to the carcass 3 also in this case and in the region of a local material accumulation 12 formed by the middle one of three ribs 13. The RFID transponder 4 in this embodiment is also provided with a protective sheath 11 and can be embedded into the rubber matrix forming the belt body 2 prior to vulcanizing and then vulcanized in the absence of any damages to said transponder 4.

Identical components and component functions are denoted by identical reference signs.

The belt 1 cannot just be of toothed or ribbed type, but of any other design also. The RFID transponder 4 can also be integrated into V-belts, flat belts, power belts and conveyor belts.

A device for driving a belt 1 according to FIGS. 3 and 4 comprises a drive unit 14, a driving wheel 16 driven by the drive unit 14 and connected thereto via a shaft 15, a reversing wheel 17 activated by the driving wheel 16 via the belt 1, a reading unit 18 for reading out the data memory 9 of the RFID transponder 4 that is arranged inside the belt 1 and a control unit 19 coacting with said reading unit 18 and said drive unit 14. Information identifying the belt 1 such as belt type, date of manufacture of a belt 1, batch number, manufacturer data, geometric information like the length of a belt 1 and/or functional information such as tensile strength or speed is stored in the data memory of the RFID transponder 4. Said belt identifying information stored in the data memory 9 can be read out in a no-contact mode by means of the reading unit 9.

Dependent on the result of a comparison between the belt identifying information read out from the data memory 9 and the reference data stored in the control unit 19 which comprises information as to belts allowed for use in the device of this invention there is a signal emitted to the drive unit 14 which disables and/or enables the drive motion of the belt 1.

The procedure of enabling and/or disabling the drive motion of the belt 1 is a follows: Following maintenance of the device and in particular an exchange of belts 1 a drive motion is transmitted to the belt 1 just like in case of a belt startup operation. It is due to said drive motion that the data memory 9 gets into the reading range 20 of the reading unit 19. The reading unit 18 sends out a carrier signal which is picked up by the antenna 10, modulated by the integrated circuit 8 as a function of the belt identifying information stored in the data memory 9 and returned to the reading unit 18. Said signal sent back and received by the reading unit 18 is now demodulated to separate the belt identifying information stored in the data memory 9 from the signal received, and transmitted to the control unit 19. The control unit 19 then compares the belt identifying information with the reference data as stored. The drive motion of the belt 1 is enabled if the belt 1 is allowed for use in the device, i.e. when the result of a comparison of the belt identifying information read out from the data memory 9 with said reference data is positive. An appropriate drive signal is to this end transmitted from the control unit 19 to the drive unit 14. The drive emotion will be disabled whenever the reference data and the belt identifying information are not in conformity.

It is possible also that upon starting of the device the RFID transponder 4 is within the reading range 20 of the reading unit 18 in which case the belt 1 does not need to be driven to position the transponder 4 in said readout area 20. The comparison between the belt identifying information stored in the data memory 9 and the reference data may instead be performed right away and with the belt 1 at standstill. The drive motion will be enabled when the comparison result is positive in which case an appropriate drive signal is transmitted from the control unit 19 to the drive unit 14 whereas the drive motion will be disabled in the event of non-compliance of the reference data with the belt identifying information.

Said comparison of the belt identifying information stored in the data memory 9 with the reference data is not just possible after maintenance work or when first starting the device after an outage thereof. It might be useful also to have the data memory 9 read out by the reading unit repeatedly, for instance at regular or coincidental intervals. This way it is possible to assess information on the speed of the drive motion, for instance. Should the RFID transponder 4 not receive a response signal within a predetermined length of time it may be concluded that there is a defect in the belt 1 or the reading unit 18. Suitable safeguarding measures, for instance a brakedown operation, may be initiated in such a case.

It is particularly in cases of repeated readout of the data memory 9 that further data additional to the belt identifying information can be read out from the data memory 9 by the reading unit 19 and processed by the control unit 19. Thus it is possible that data may be picked up by not-shown sensors and stored in the data memory 9. These sensors can be integrated in the body 2 of the belt 1 the way as described for the RFID transponder 4 itself. It is possible also to apply sensors to the belt 1 from externally or even outside the belt 1. The data collected by said sensors and stored in the data memory 9 may for instance comprise information on elongation, forces acting inside the belt or temperature information. Following readout of these additional parameters the control unit 19 can evaluate them, for example to monitor the wearing state of the belt 1.

1. A belt for transmitting a drive motion, comprising
a belt body of an elastic material and
a carcass that extends in the longitudinal direction of the belt and that is at least partially surrounded by the belt body for increasing the strength of said belt body in the longitudinal direction of the belt,
wherein a data memory for saving data is situated in the belt body,
wherein the data stored in the data memory (9) comprise at least one piece of information that identifies the belt and
wherein the drive motion can be disabled and/or enabled in accordance with the stored information that identifies the belt.

2. The belt according to claim 1, wherein the data memory (9) at least partially surrounded by the material of the belt body (2) is arranged in the region of a neutral fiber (F) of the belt body (2) which when bent around a bending axis (B) extending cross to the belt longitudinal direction (R) is not subjected to tension and/or pressure, and/or the data memory (9) at least partially surrounded by the material of the belt body (2) is arranged in the region of the carcass (3) and/or in the region of a local material accumulation (12) of the belt body (2).

3. The belt according to claim 1, wherein the data memory (9) is part of an integrated circuit (8) which together with an antenna (10) coupled to said integrated circuit (8) forms an RFID transponder (4) and can be read out in a no-contact mode.

4. The belt according to claim 1, wherein the data memory (9) and/or the integrated circuit (8) and/or the antenna (10) are at least partially surrounded by a protective sheath (11).

5. The belt according to claim 1, wherein the protective sheath (11) is tight and contains no or just little air.

6. The belt according to claim 1, wherein the protective sheath (11) consists of a glass and/or plastic material.

7. A device for driving a belt which is used to transmitting a drive motion and in which a data memory for saving data, a reading unit for reading out the data memory and a drive unit for driving the belt are arranged,
wherein a belt identifying information is stored in the data memory (9) of the belt (1) and
wherein a control unit coacting with the reading unit (18) and the drive unit (14) is provided such that a drive signal can be emitted to the drive unit (14) for disabling and/or enabling the drive motion of the belt (1) in accordance with the result of a comparison between the belt identifying information and stored reference data.

8. The device according to claim 7, wherein as reference data representing a belt identifying information an allowed belt type is stored at least.

9. A method for starting a belt wherein the belt provided with a data memory is driven by a drive unit, wherein at least one piece of information that identifies the belt is read out from the data memory (9) of the belt (1) and compared for compliance with reference data such that a drive motion of the belt (1) is enabled in case of conformity and/or disabled in case of non-conformity between the results of that comparison.

10. The method according to claim 9, wherein the data memory (9) is read out in a non-recurrent or a recurrent mode wherein non-receipt of a belt identifying information to be read out from the data memory (9) in a no-contact mode by a reading unit (18) and to be transmitted to a control unit (19) controlling the drive unit (14) indicates that there is a defect in the belt (1) and/or the reading unit (18) and/or that operational parameters at least temporarily stored in the data memory (9) in addition to said belt identifying information are read out which parameters have been transmitted to the data memory (9) by sensors arranged inside and/or outside the belt (1).

11. The method according to claim 9, wherein such operational parameters that influence the service life of the belt (1), in particular temperature, pressure and/or elongation values, are detected, stored in the data memory (9) and/or read out by the reading unit (18) to indicate the need for service and/or safeguarding measures and/or to initiate said latter.
